(19) United States
(12) Patent Application Publication
(10) Pub. No.: US 2008/0012301 A1
(43) Pub. Date: Jan. 17, 2008

(54) Fitting for metal pipe and tubing

(75) Inventors: Dale Conrad Arstein, Highland Heights, OH (US); Mark A. Bennett, Bainbridge Township, OH (US); Tobin Berry, Chagrin Falls, OH (US); Richard J. Medvick, Cleveland Heights, OH (US); Jeffrey Michael Rubinski, Wickliffe, OH (US); Xiaoli Tang, Seven Hills, OH (US); Peter C. Williams, Cleveland Heights, OH (US)

Correspondence Address: CALFEE HALTER & GRISWOLD, LLP, 800 SUPERIOR AVENUE, SUITE 1400, CLEVELAND, OH, 44114, US

(73) Assignee: Swagelok Company

(21) Appl. No.: 10/559,316

(22) PCT Filed: Nov. 3, 2004
(86) PCT No.: PCT/US04/36677

§ 371 Date: Dec. 5, 2005

Related U.S. Application Data
(60) Provisional application No. 60/481,593, filed on Nov. 3, 2003.

(51) Int. Cl. F16L 47/00

(52) U.S. Cl. 285/249

(57) ABSTRACT

A fitting arrangement with an adapter for use in a fitting that uses a fitting body and nut of certain commonly used dimensions as described above, while retaining the gripping capability. The adapter is a ring that seals effectively against the body, while presenting a less shallow camming mouth for engagement by a ferrule. This combination of parts enables effective tube grip, fluid seal, and vibration protection.

This application claims the benefit of the filing date of U.S. Provisional Application No. 60/481,593 filed Nov. 3, 2003, the entire disclosure of which is incorporated by reference.

### TECHNICAL FIELD OF THE INVENTION

The subject invention is generally directed to the art of fittings for pipe and tube. More particularly, the invention is directed to flareless fittings that include a fitting body with a shallow angle tapered surface and a tube gripping device, such as a ferrule or tube gripping ring.

This application incorporates by reference the entire disclosure of International patent application no. PCT/US02/03430 filed on Feb. 6, 2002 for TUBE FITTING FOR STAINLESS STEEL TUBING.

### BACKGROUND OF THE INVENTION

Some known tube fittings employ parts that are at least partially standardized in dimension or configuration, thus being commonly used. For example, many fitting bodies have a shallow camming mouth or tapered surface, for example, twelve degrees (12°) or twenty degrees (20°), for engagement by a ferrule when the ferrule is forced against it by the nut. Many nuts have a forty-five degree (45°) angle on their drive face that contacts the ferrule to drive the ferrule against the camming mouth of the body. The gradual nature of the 12° camming angle on the body is conducive to embedding the ferrule into the tube surface to provide grip. This 12° angle is, however, not conducive to establishing a good seal between the ferrule and the body. Thus, the gripping and sealing functions are often at odds with each other in a fitting using such parts. The sealing function is often enhanced by adding an elastomeric seal element to the fitting. While fittings using elastomeric sealing elements generally seal effectively, they can have some drawbacks. For example, temperature limitations may be placed on the fitting because of the presence of the elastomeric (non-metallic) element. Incompatibilities may exist between the elastomeric seal element and certain system fluids. In addition, seal clipping or damage may occur during fitting make-up, or the seal element may fall out or be lost prior to fitting make-up.

### SUMMARY OF THE INVENTION

The present invention is directed to improving the sealing capability of a fitting that uses a fitting body and nut of certain commonly used dimensions as described above, while retaining the gripping capability. This is accomplished by providing a metal adaptor ring that seals effectively in a metal-to-metal manner against the body, while presenting a less shallow camming mouth for engagement by a ferrule. This combination of parts enables effective tube grip, fluid seal, and vibration protection.

### BRIEF DESCRIPTION OF THE DRAWINGS

These and other aspects and advantages of the present invention will be apparent to those skilled in the art from the following description of the preferred embodiments in view of the accompanying drawings, in which:

FIG. 1 is an embodiment of the invention for a single ferrule tube fitting including an adaptor ring;

FIG. 2 is another embodiment similar to FIG. 1 including an adaptor ring;

FIG. 3 is another embodiment similar to FIG. 1 including an adaptor ring;

FIG. 4 is another embodiment similar to FIG. 1 including an adaptor ring;

FIG. 5 is another embodiment similar to FIG. 1 including an adaptor ring;

FIG. 6 is another embodiment similar to FIG. 1 including an adaptor ring;

FIGS. 7-9 are schematic illustrations of portions of adaptor rings that are other embodiments of the invention;

FIG. 10 illustrates another adaptor ring used with a single ferrule tube fitting;

FIG. 11 illustrates an adaptor ring used with a two ferrule tube fitting; and

FIG. 12 illustrates a self-energizing effect of a tube fitting of the present invention.

### DETAILED DESCRIPTION OF THE INVENTION

In many tube fittings, the nose of a ferrule is cammed inward toward and into the tube by a shallow (for example, 12° or 20°) camming surface or tapered surface on the fitting body. This angle is suitable for effecting tube gripping by the ferrule but is not optimal for also effecting a seal on the body by the ferrule. On the other hand, a steeper (for example, 45°) camming angle, can be better to effect a seal by the ferrule but can be less effective at producing the needed grip. The present invention as described below with reference to exemplary (but not limiting) embodiments addresses this issue.

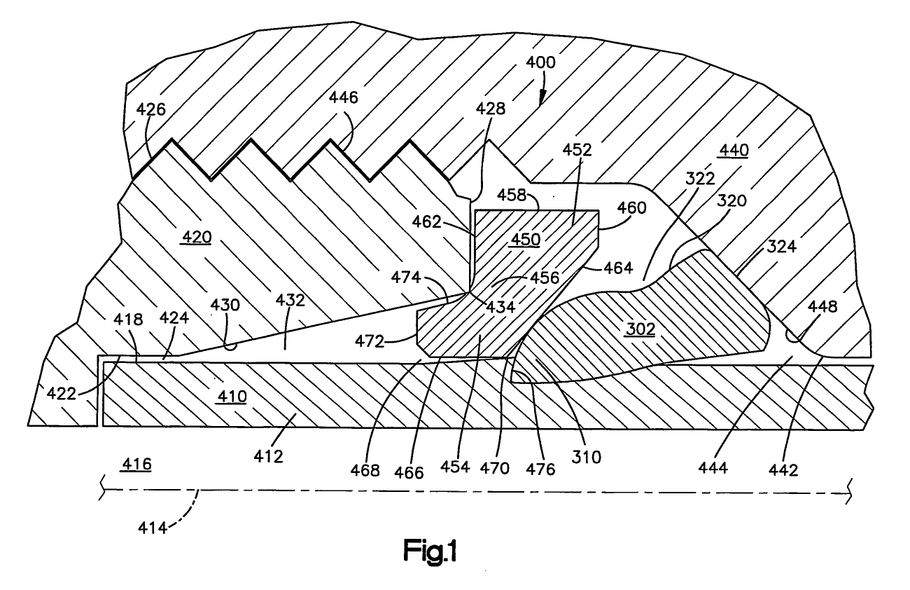

FIGS. 1-4 illustrate different tube fittings 400, 400a, 400b, and 400c in accordance with the invention. The various fittings 400-400c include differing features and combinations of features. A tube fitting in accordance with the present invention can include one or more of these features in different combinations.

Showing one representative embodiment, FIG. 1 illustrates a tube fitting 400 in accordance with the invention, for use in coupling a tube 410 to a body 420. The fitting 400 includes a driver or drive nut 440, an adaptor ring 450, and a ferrule 302. The body 420 and the drive nut 440 may have some “standard” features or dimensions, that is, features or aspects that are commonly found on some fittings, as described below.

The tube 410 as illustrated has a cylindrical side wall 412 centered on an axis 414. The side wall 412 defines a fluid flow passage 416 in the tube 410. The tube side wall 412 has a cylindrical outer surface 418 centered on the axis 414. (As used herein, the term “tube” is intended to cover hollow cylindrical pipes of different and varying diameters, including those commonly known as tube, pipe, and conduit.)

The body 420 has a cylindrical inner surface 422 centered on the axis. The surface 422 defines a bore or tube socket 424 in which the end of the tube 410 is received. The body 420 has an external thread convolution 426 for engagement with the nut 440, as described below. The fitting 400 is adapted to seal between the body 420 and the tube 410, and to secure them to each other so that the tube does not come out of the bore 424 in the body.

The body 420 has an annular end surface or back face 428 that extends radially inward from the thread convolution 426. The body 420 also has a frustoconical camming surface or tapered surface 430 that extends between the inner surface 422 and the end surface 428. The camming surface 430 extends at an angle to the axis 414. In one exemplary embodiment, as shown, the camming surface 430 extends at about a 12° angle to the axis 414. The camming surface 430 is presented radially inward toward the axis 414 and axially in a direction toward the drive nut 440. The camming surface 430 is located adjacent to the surface 422 and defines a camming mouth 432 of the body 420 that is located adjacent to the tube socket 424. The body 420 has an edge 434 at the intersection of the camming surface 430 and the end surface 428.

The driver or nut 440 includes a first cylindrical surface or inner surface 442 centered on the axis 414. The surface 442 defines a bore 444 through which the tube 410 extends. At a location radially outward and spaced axially from the inner surface 442, the nut 440 has an internal thread convolution 446 for engagement with the external thread 426 on the body 420.

The nut 440 has a frustoconical drive surface or drive face 448 that extends radially and axially between the inner surface 442 and the internal thread 446. The drive face 448 extends at an angle to the axis 414 and is presented radially toward the axis and axially toward the body 420. In the embodiment shown in FIG. 1. the drive face 448 extends at about a 45° angle to the axis 414. The nut drive angle may be other than 45°.

The adaptor ring 450 and the ferrule 302 are located in the space between the drive face 448 of the nut 440 and the body 420. The adaptor ring 450 can be, but need not be, made from the same material as the ferrule 302.

The adaptor ring 450 in the embodiment of FIG. 1 has a radially outer portion 452 and a radially inner portion 454 that are joined by a neck portion 456. The outer portion 452 of the adaptor ring 450 has a cylindrical outer surface 458 that extends parallel to the axis 414. The outer portion 452 of the ring 450 has an annular back face 460 that extends radially inward from the back end of the outer surface 458, in a direction normal to the outer surface and to the axis 414. The back face 460 is presented axially in a direction toward the nut 440.

The outer portion 452 of the ring 450 also has an annular front face 462 that extends radially inward from the front end of the outer surface 458, in a direction normal to the outer surface and to the axis 414. The front face 462 is presented axially in a direction toward the end surface 428 of the body 420. In the particular adaptor ring 450 that is shown in FIG. 1, the front face 462 has a greater radial extent than the back face 460, for example, two times the radial extent of the back face.

The adaptor ring 450 has a camming surface 464 that is presented radially inward toward the axis 414 and also is presented axially toward the back of the fitting, in a direction toward the drive face 448 of the nut 440. The camming surface 464 extends at an angle to the axis 414, which, in the embodiment illustrated in FIG. 1, is an angle of about 45°.

The inner portion 454 of the adaptor ring 450 has a cylindrical inner surface 466 that extends parallel to the axis 414. The inner surface 466 defines a bore 468 in which the tube 410 is slidably received. The inner surface 466 overlies and is spaced apart from the outer surface 418 of the tube 410, before the fitting 400 is made up. The adaptor ring 450 has an edge 470 at the intersection of the inner surface 466 and the camming surface 464.

The inner portion 454 of the ring 450 has an annular front face 472 that extends radially outward from the inner surface 466, in a direction normal to the inner surface and to the axis 414. The front face 472 is presented axially in a direction toward the camming mouth 432 of the body 420. The front face 472 of the inner portion 454 of the ring is farther forward in the fitting 400, that is, is located closer to the body 420 and farther from the nut 440, than is the front face 462 of the outer portion 452 of the ring. A chamfer breaks the edge defined by surface 462 and surface 472.

The inner portion of the adaptor ring 450 also has an engagement surface 474 that extends between and interconnects the front face 472 of the inner portion 454 of the ring, and the front face 462 of the outer portion 452 of the ring. The engagement surface 474 may be a single concave or planar surface, or may be a series of concave or planar surfaces, or a combination of various types of surfaces. The engagement surface 474 spans the neck portion 456 of the adaptor ring 450, extending between the front face 472 of the inner portion 454 and the front face 462 of the outer portion 452. The engagement surface 474 is presented toward the body 420 and, specifically, toward the edge 434 on the body. On the opposite side of the adaptor ring 450, the camming surface 464 of the adaptor ring 450 spans the neck portion 456 of the adaptor ring, extending between the inner surface 466 and the back face 460 of the outer portion 452.

The dimensions of the adaptor ring 450 are selected so that its radially inner portion 454 can move into the camming mouth 432 of the body 420, while the radially outer portion 452 can not. Specifically, movement of the adaptor ring 450 in a direction axially toward the camming mouth 430 of the body 420 is blocked, as described below, by engagement of the adaptor ring engagement surface 474 (or the front face 462) with the body 420.

When the fitting 400 is made up, the nut 440 is tightened on the body 420, and moves axially toward the body (in a direction to the left as viewed in FIG. 1). The 45° drive face 448 of the nut engages the back wall 324 of the ferrule 302. The ferrule 302 is driven forward until it engages the adaptor ring 450. The nose 310 of the ferrule 302 engages the 45° back face 464 of the adaptor ring 450.

The adaptor ring 450 is moved forward by the ferrule 302 until it engages the body 420. The engagement surface 474 of the adaptor ring 450 engages the edge 434 on the body 420 to act as a stop for the adaptor ring. This engagement blocks any further substantial movement of the adaptor ring 450 toward the body 420, and may be sensed by sensing torque on the nut 400 to determine sufficient pull up. The adaptor ring 450 is captured between the ferrule 302 and the body 420, and the ferrule is captured between the adaptor ring and the nut 440.

The inner portion 454 of the adaptor ring 450 is located in the camming mouth 432 of the body 420, radially inward of the camming surface 430 but not in engagement with the camming surface. Alternatively, the adaptor ring 450 can engage the camming surface 430. The outer portion 452 of the adaptor ring 450 is located radially outward of the camming surface 430 of the body 420, and axially between the end face 428 of the body and the drive face 448 of the nut 440.

As the nut 440 is tightened further, the ferrule 302 is compressed and plastically deformed, and is driven into gripping and sealing engagement with the adaptor ring 450 and the tube 410. The ferrule 302 may hinge and/or collet, and may be hardened to make it more suitable for use with the relatively steep 45° camming angle of the adaptor ring 450.

The nose 310 of the ferrule engages the 45° camming surface 464 on the adaptor ring, rather than the 12° camming surface 430 on the body 420. Thus, the nose 310 of the ferrule 302 is cammed radially inward toward and into the tube 410 by a 45° camming surface, rather than by a 12° camming surface.

A seal is established between the engagement surface 474 of the adaptor ring 450 and the edge 434 of the body 420. This seal prevents fluid from the tube 410 from passing radially outward of the adaptor ring 450. This seal is not a sliding seal, that is, is not of the type established when a ferrule cams and slides against a camming surface of a fitting body. In contrast, the adaptor ring 450 is positively stopped from movement relative to the body 420, and the engagement surface 474 thus seals in a fixed manner against the edge 434 of the body. The adaptor ring 450 does not have to establish a seal against the tube 410.

Another seal is established between the nose 310 of the ferrule 302 and the camming surface 464 of the adaptor ring 450. A third seal is established between the nose 310 of the ferrule 302 and the tube 410. These seals together provide the desired sealing function of the fitting 400, preventing fluid from passing radially inward of the adaptor ring. At the same time, the nose 310 of the ferrule 302 is driven into the material of the tube 310 to form a generally radial shoulder 476, blocking removal of the tube from the bore 424 in the body 420 and thus providing the desired gripping function of the fitting 400. The underside of the adaptor ring can be configured to allow space for the chip of tubing that is curled up by the ferrule nose. Thus, with the use of the adaptor ring 450, the fitting 400 can give up the increased grip benefit of the 12° camming surface, because excellent grip is provided from the ferrule 302, that is cammed into the tube by the 45° camming surface of the adaptor ring.

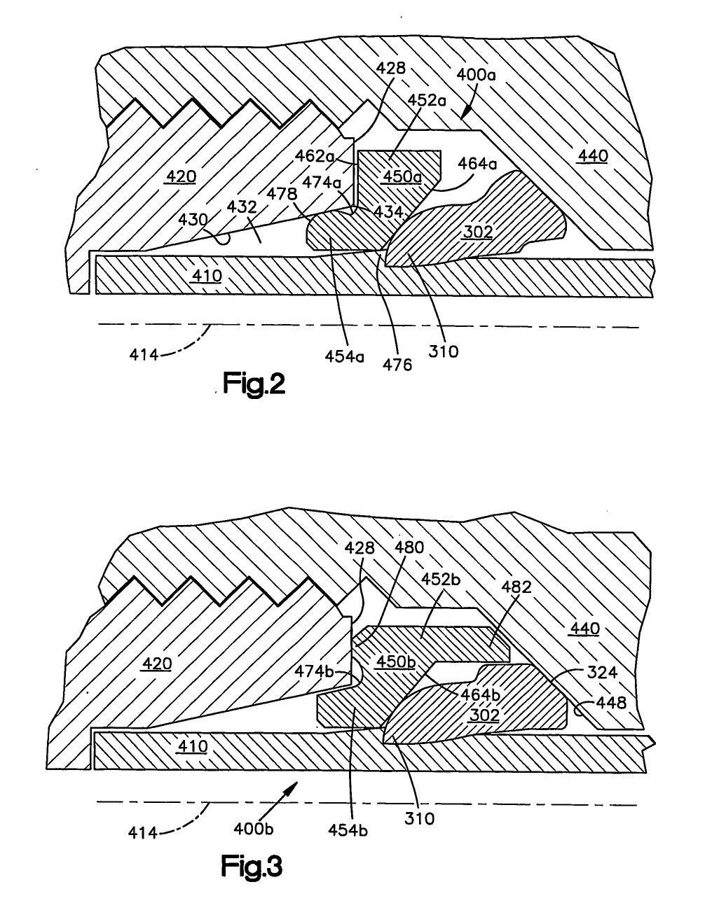

FIG. 2 illustrates a tube fitting 400a that is similar to the tube fitting 400 but which uses a different adaptor ring. The fitting 400a, for use in coupling the tube 410 to the body 420, includes the same drive nut 440 and the same ferrule 302. The fitting 400a also includes an adaptor ring 450a which is slightly different from the adaptor ring 450 shown in FIG. 1. Specifically, in the adaptor ring 450a, the radially inner portion 454a is different than the radially inner portion 454 in the adaptor ring 450. Also, the engagement surface 474a in the adaptor ring 450a is different than the engagement surface 474 in the adaptor ring 400.

The radially inner portion 454a of the adaptor ring 450a has a convex configuration including a convex outer surface 478 presented toward the camming surface 430 of the body 420. The convex outer surface 478 merges into a concave engagement surface 474a that merges into the front face 462a of the radially outer portion 452a of the adaptor ring 450a. The resulting configuration of the adaptor ring 450a includes a “bullnose” shaped inner portion 454a that still fits into the camming mouth 432 of the body 420, but that also projects radially outward sufficiently to engage the camming surface 430 of the body when the fitting 400a is made up.

When the drive nut 440 pushes the ferrule 302 into the adaptor ring 450a, the adaptor ring is pushed into engagement with the body 420, as shown in FIG. 2. The outer surface 478 of the inner portion 454a of the adaptor ring is wedged into tight engagement with the camming surface 430 of the body 420. The radially extending front face 462a of the outer portion 452a of the adaptor ring 450 preferably engages the end face 428 of the body to provide a stop. The concave engagement surface 474a of the adaptor ring 450a may or may not engage the edge 434 of the body 420.

In the embodiment of FIG. 2, the adaptor ring 450a is interposed between the ferrule 302 and the body 420, so that the nose 310 of the ferrule engages the 45° camming surface 464a on the adaptor ring, rather than the 12° camming surface 430 on the body 420. A seal is established between the convex outer surface 478 on the radially inner portion 454a of the adaptor ring 450a and the camming surface 430 of the body 420. Another seal is established between the nose 310 of the ferrule 302 and the camming surface 464a of the adaptor ring 450a. A third seal is established between the nose 310 of the ferrule 302 and the tube 410. These seals together provide the desired sealing function of the fitting 400a. At the same time, the nose 310 of the ferrule 302 is driven into the material of the tube 310 to form a generally radial shoulder 476, blocking removal of the tube from the body 420 and thus providing the desired gripping function of the fitting 400a.

FIG. 3 illustrates a tube fitting 400b that is similar to the fittings 400 and 400a, but including a different adaptor ring. The fitting 400b, for use in coupling the tube 410 to the body 420, includes the same drive nut 440 and the same ferrule 302 (with a shortened back wall 324). The fitting 400b also includes an adaptor ring 450b which is different from the adaptor ring 450 shown in FIG. 1 and from the adaptor ring 450a shown in FIG. 2.

The adaptor ring 450b has an outer portion 452b that is longer axially than the outer portion of either of the rings 450 and 450a. The outer portion 452b of the adaptor ring 450b includes a nose portion 480 that projects forward (in a direction toward the body 420), overlying the inner portion 454b of the ring and extending past the surface 474b. The outer portion 452b also includes a tail portion 482 that projects backward (in a direction toward the nut 440), overlying a significantly greater part of the ferrule 302 (in the illustrated embodiment, over most of the ferrule) than does the outer portion 452 of the adaptor ring 450 (FIG. 1).

When the fitting 400b is made up, as shown in FIG. 3, the nose portion 480 of the adaptor ring engages the end face 428 of the body 420 to act as a stop for movement of the adaptor ring. This engagement limits further movement of the adaptor ring 450b in a direction toward the body 420 and provides a seal between the adaptor ring and the body. The nose 310 of the ferrule 302 engages the camming surface 464b of the adaptor ring 450b to provide a seal, and is cammed into the tube 410, as described above, to grip and to provide an additional seal.

When the fitting 400b is made up, the tail portion 482 engages the drive face 448 of the nut 440 to as a stop to limit movement of the nut 440 in a direction toward the body 420. This can provide torque sensing to ensure sufficient pull up of the fitting 400b.

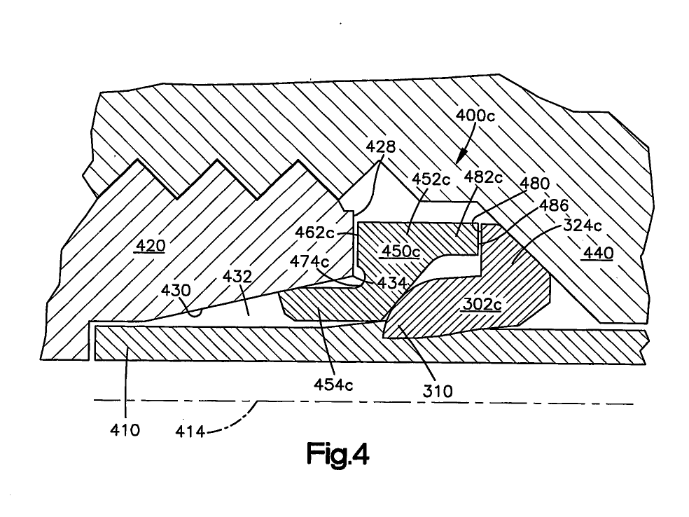

FIG. 4 illustrates a tube fitting 400c that is similar to the fittings 400, 400a and 400b, and including a different adaptor ring and ferrule. The fitting 400c, for use in coupling the tube 410 to the body 420, includes the same drive nut 440. The fitting 400c also includes an adaptor ring 450c which is different from the adaptor rings 450, 450a, and 450b. The fitting 400c also includes a ferrule 302c which is different from the ferrule 302.

The back wall 324c of the ferrule 302c extends radially outward farther than the back wall 324 of the ferrule 302 (FIG. 1). A stop surface 480 on the back wall 324c of the ferrule 302c is presented toward the body 420.

The outer portion 452c of the adaptor ring 450c includes a tail portion 482c that projects backward (in a direction toward the nut 440), overlying a significantly greater part of the ferrule 302 than does the outer portion 452 of the adaptor ring 450 (FIG. 1). The tail portion 482c of the adaptor ring 450c includes a stop surface 486 that is presented toward the nut 440 and the back wall 324c of the ferrule 302c.

The inner portion 454c of the adaptor ring 450c is elongated axially in a forward direction, compared to the inner portion 454 of the adaptor ring 450 (FIG. 1). The inner portion 454c of the adaptor ring 450c, like the bullnose on the adaptor ring 454a (FIG. 2), moves into the camming mouth 432 of the body 420 and engages the camming surface 430 of the body. The inner portion 454c of the adaptor ring 450c seals against the tapered surface 430 of the body 420. The concave engagement surface 474c of the adaptor ring 450c, and the radially extending front face 462c of the outer portion 452c of the ring, may or may not engage the edge 434 of the body 420 and/or the end face 428 of the body.

When the fitting 400c is made up, the stop surface 486 on the tail portion 482c of the adaptor ring 450c engages the stop surface 480 on the back wall 324c of the ferrule 302c. At the same time, the front face 462c of the adaptor ring 450c engages the end surface 428 of the body 420. As a result, the outer portion 452c of the adaptor ring 450c and the back wall 324c of the ferrule 302, together, act as a stop to limit movement of the nut 440 in a direction toward the body 420. This can provide torque sensing to ensure sufficient pull up of the fitting 400c.

FIG. 5 illustrates a tube fitting 400d for use in coupling a tube 410 to a fitting body 420. The fitting body 420 has a 12° camming surface 430 that defines a camming mouth 432. The fitting 400d includes a drive nut 440. The fitting 400d also includes an adaptor ring 450d and a ferrule 302d.

The adaptor ring 450d has an extended nose 490 that fits into the camming mouth 432. The nose 490 has a sharp edge 492 that digs into the camming surface 430, upon make-up, to provide a seal between the adaptor ring 450d and the fitting body 420. The ferrule 302d has a relatively small nose 496 that fits under the relatively small 45° camming mouth 494 of the adaptor ring 450d. The ferrule 302d seals against the 45° back end or camming mouth 494 of the adaptor ring 450d and grips on the tube 410.

The fitting 400d does not have a positive stop built into it. Instead, the fitting 400d is designed to be pulled up a given number of turns of the nut, thereby ensuring sufficient pull up of the fitting.

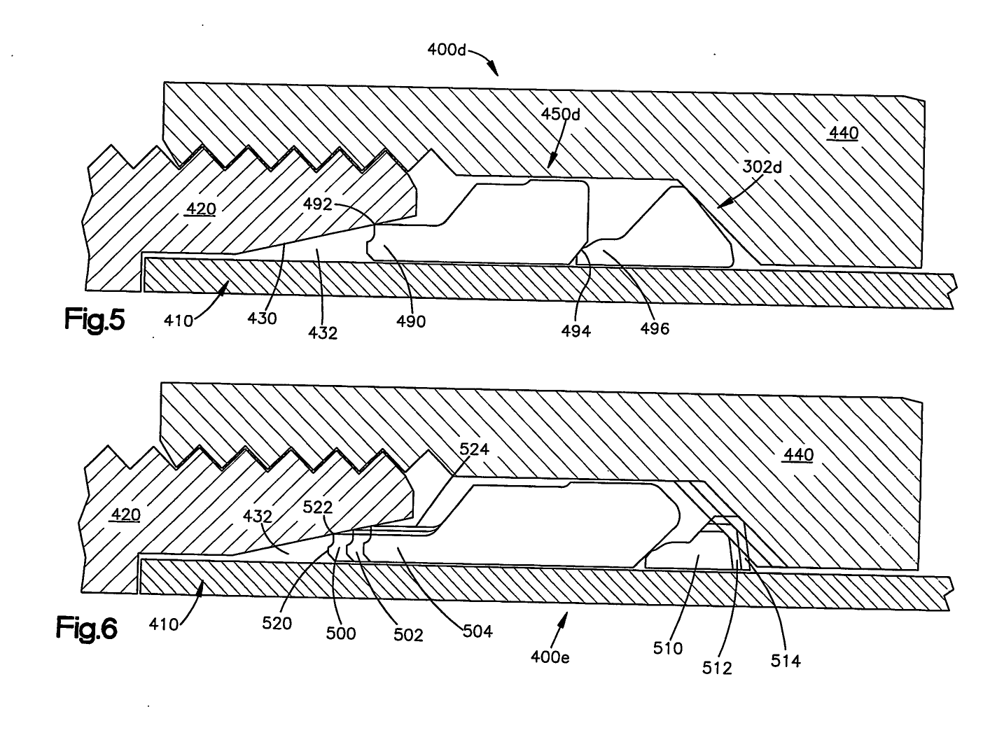

FIG. 6 illustrates a tube fitting 400e for use in coupling a tube 410 to a fitting body 420. The fitting 400e includes a drive nut 440. The fitting 400e also includes one of three different adaptor rings 500, 502, and 504 that are illustrated, and one of three different ferrules 510, 512 and 514 that are illustrated. As a result, there are nine possible combinations of the illustrated parts.

The one adaptor ring 500 has a long and slender nose 520 that fits into the camming mouth 432. The nose 520 has a sharp edge 522 that digs into the camming surface to provide a seal between the adaptor ring 500 and the fitting body 420. Because the nose 520 is long and slender, it produces less tendency to swell out the fitting body 420 when the fitting 400d is made-up.

The adaptor ring 504, in contrast, has a shorter and thicker nose 524 that seals between the adaptor ring and the fitting body 420. Because the nose 524 of the adaptor ring 504 is shorter and thicker in cross-section, it has a greater resistance to axial compression under load. The qualities of the intermediate adaptor ring 502 illustrated fall between the qualities of the rings 500 and 504. The three nose designs are illustrated to show that the length and thickness of the nose are variables and that the designer can select between them or can select a nose with a different length and thickness.

The fitting 400e has a positive stop built into it. This can provide torque sensing to ensure sufficient pull up of the fitting. Specifically, the nut 440 is designed to bottom out on the adaptor ring 500-504. The three different ferrules 510-514 that are illustrated in FIG. 6 have different lengths and heights and thus allow for differing amounts of nut travel before the nut 440 bottoms out on the back of the adaptor ring 500-504. The three ferrule designs 510-514 are illustrated to show that the size of the ferrule is a variable and that the designer can select between them or can select a ferrule with different dimensions. The choice of adaptor ring is dependent on which one effectively makes a seal against the camming mouth without swelling the body while resisting axial compression under load. The choice of ferrule is based on to what extent it is desired to have the ferrule grip into the tube by the time the nut stops against the back side of the adaptor ring.

As noted above, the ferrule grips the tube to prevent the tube from coming out of the tube socket in the fitting body. Under high pressure, a significant amount of strain can be present in the tube, evidenced as an axially outwardly directed force on the tube and on any component that is attached to or gripping the tube. Sufficient strain on the tube, if transmitted to the adaptor ring, can break or reduce the seal between the adaptor ring and the body. It is preferable to prevent this from occurring.

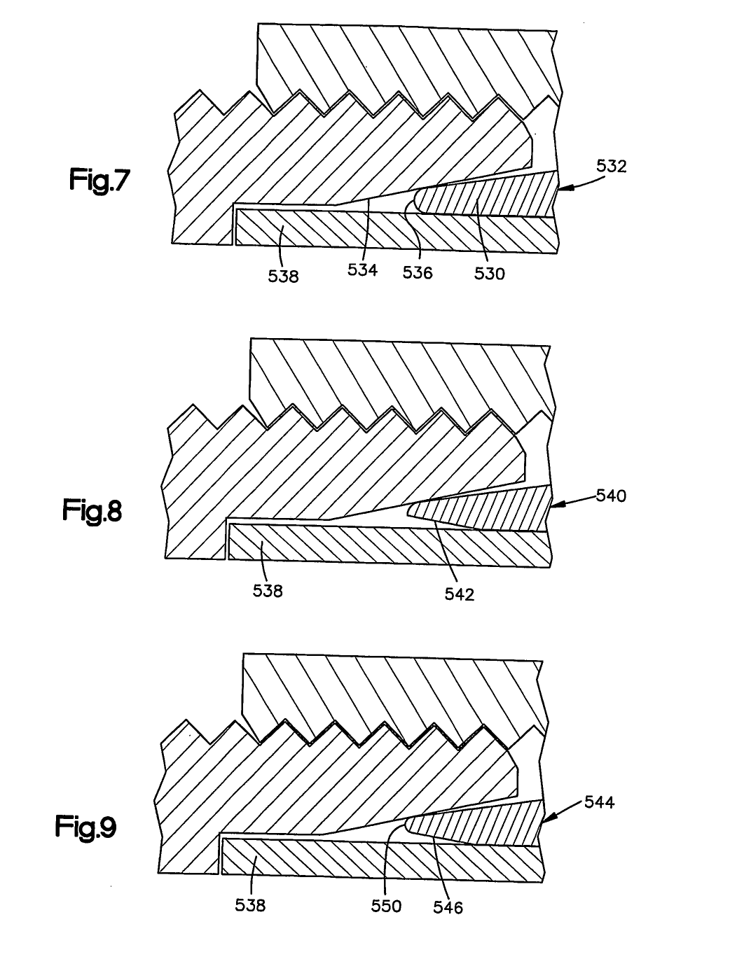

As illustrated schematically in FIG. 7, the nose 530 of the adaptor ring 532, that is, the portion that is located radially inward of the camming surface 534, can have a rounded tip 536. This helps to avoid transmission of tube strain under high pressure to the adaptor ring.

In a second manner, the nose of the adaptor ring, that is, the portion radially inward of the camming surface, can be ramped or chamfered radially outward, away from the outer surface of the tube, as illustrated schematically in FIG. 8. The adaptor ring 540 shown in FIG. 8 is illustrated as having an inner ramp surface or chamfer 542 that tapers radially outward as measured in a direction from the back of the ring toward the tip of the ring.

Third, the nose of the adaptor ring can be both rounded and ramped, as illustrated schematically by the adaptor ring 544 shown in FIG. 9.

In these manners, or in another manner, with an adaptor ring so configured, then under high pressure the tube can freely move and strain outward. As other examples, an elliptical end portion can be provided, or the nose portion can be broken off by broaching, for example, to provide the desired non-sharp configuration for the nose portion or end portion of the adaptor ring. Combinations of tapers and curved surfaces are also possible. The features of the adaptor rings shown in FIGS. 7-9 and as described herein can equally apply to all the adaptor rings illustrated. During pull up, if the inside forward portion of the adaptor ring comes in contact with the tube, it touches with a negative rake angle with respect to the tube surface, that is, an acute angle between the tube surface and the surface of the inside forward portion of the adaptor ring.

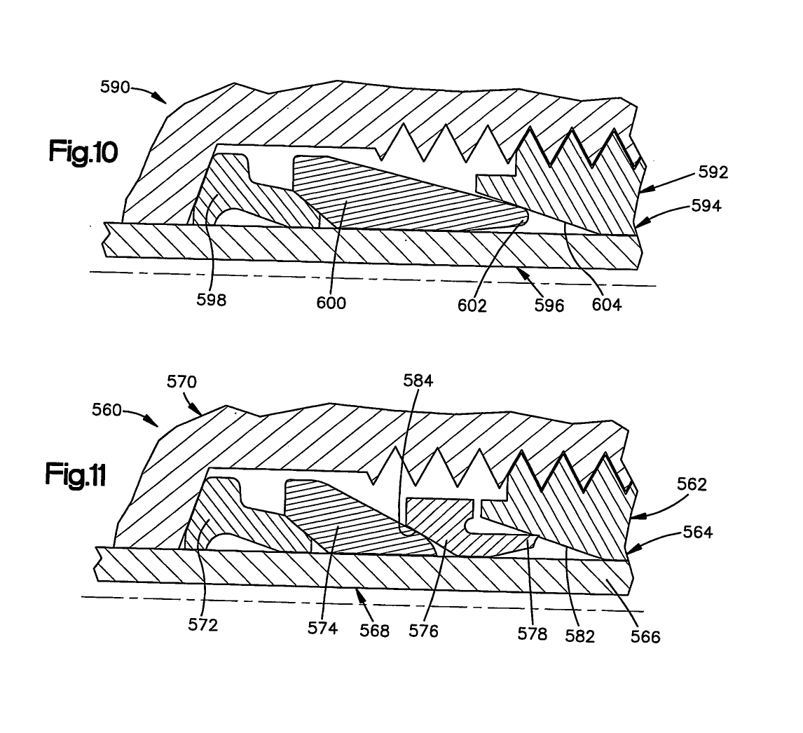

FIGS. 10 and 11 show two further embodiments of the invention. FIG. 10 illustrates a tube fitting 590 including a fitting body 592 having a tube socket 594 receiving an end portion of a tube 596, a ferrule 598, and an adaptor ring 600. The adaptor ring 600 is illustrated as having a taper and rounded tip 602.

FIG. 11 illustrates a two ferrule tube fitting 560 including a fitting body 562 having a tube socket 564 receiving an end portion 566 of a tube 568. A driver 570 in the form of a nut is coupled to the fitting body 562 to drive a back ferrule 572, a front ferrule 574, and an adaptor ring 576. The adaptor ring 576 has a nose portion 578 that seals against a relatively shallow, twelve degree to twenty degree tapered surface 582 on the fitting body 562. The adaptor ring 576 has a back face 584 that forms a relatively less shallow camming surface, in the range of from about 30 degrees to about 45 degrees that is engaged by the nose portion of the front ferrule 574. The back ferrule 572 is captured between the front ferrule 574 and the nut 570. Upon make up (not shown) of the fitting 560 both the front ferrule 574 and the back ferrule 572 grip and seal on the tube 568. In this embodiment, as well as in the embodiment of FIG. 10, sufficient pull up of the fitting can be ensured by torque sensing or in another manner, such as by ensuring sufficient axial stroke of the nut as determined by number of turns of the nut.

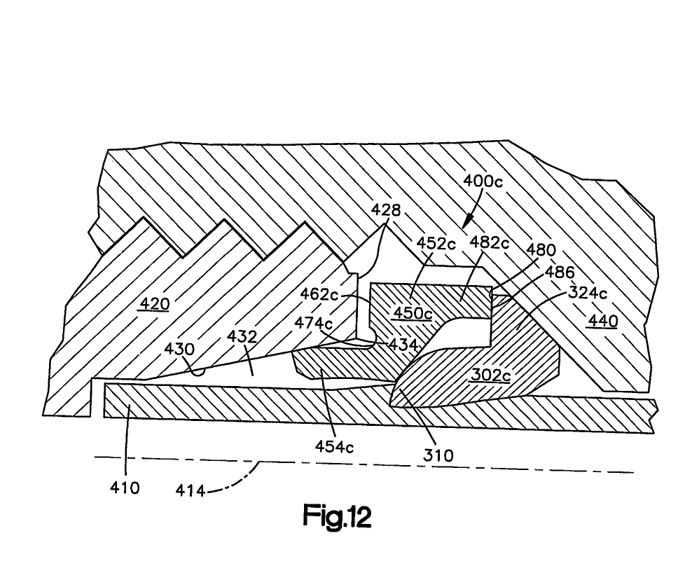

FIG. 12 illustrates a self-energizing effect under high pressure of an adaptor ring in accordance with the invention. The ring illustrated is the adaptor ring 450c that is discussed above with reference to FIG. 4. Under very high pressure, the tube 410 may begin to pull out of the tube socket in the fitting body 420. As this occurs, the ferrule 302c bites deeper into the material of the tube 410 to resist tube pullout and seal better. Fluid under pressure flows into the annular cavity that is located radially outward of the tube 410 and radially inward of the adaptor ring 450c. The fluid pressure acts to force the adaptor ring 450c away from the tube 410. The nose portion 454c of the adaptor ring 450c is pressed more tightly against the camming surface 430 of the fitting body 420. The adaptor ring 450c is also pressed more tightly against the ferrule 302c. As a result, the sealing capability of the adaptor ring 450c is increased because of the increased pressure in the tube 410.

From the above description of the invention, those skilled in the art will perceive improvements, changes, and modifications in the invention. Such improvements, changes, and modifications within the skill of the art are intended to be included within the scope of the appended claims.

1. A tube fitting for connection with an end portion of a tube, said tube fitting comprising: a fitting body having a tube socket for receiving the end portion of the tube, said fitting body including a tapered surface that is centered on an axis of the fitting body, the tapered surface extending at a first angle to the axis; a ferrule having a front portion and a rear portion; an adaptor ring; and a driver for applying axial force to the ferrule rear portion to move the ferrule front portion into engagement with said adaptor ring; said adaptor ring having a camming surface extending at a second angle to the axis for engagement by the ferrule front portion; said adaptor ring being in sealing engagement with said fitting body when said fitting is made up; said adaptor ring having a forward inside portion that has a negative rake angle with respect to the tube.

2. A tube fitting as set forth in claim 1 wherein the sealing engagement of said adaptor ring with said fitting body is metal to metal engagement.

3-15. (canceled)

16. A tube fitting for connection with an end portion of a tube, said tube fitting comprising: a fitting body having a tube socket for receiving the end portion of the tube, said fitting body including a tapered surface that is centered on an axis of the fitting body, the tapered surface extending at a first angle to the axis; a ferrule having a front portion and a rear portion; an adaptor ring; and a driver for applying axial force to the ferrule rear portion to move the ferrule front portion into engagement with said adaptor ring; said adaptor ring having a camming surface extending at a second angle to the axis, the second angle being different from the first angle; said adaptor ring having a sealing surface for engagement with the fitting body at a sealing location spaced apart from said tapered surface of said fitting body.

17. A tube fitting as set forth in claim 16 wherein said sealing location of said fitting body is an end face of said fitting body.

18-57. (canceled)

58. A fitting for fluid tight connection with an end portion of a tube, the fitting comprising:
a fitting body that receives the end portion of the tube along a central axis;
an adapter in sealing engagement with the fitting body when the fitting is pulled up; the adapter having an internally tapered forward end portion radially spaced from the tube before the fitting is pulled up and a rear portion that defines a camming surface;
a ferrule that engages the camming surface such that the camming surface forces a front portion of the ferrule into gripping engagement with the tube when the fitting is pulled up;
wherein the adapter remains in sealing engagement with the fitting body while allowing the tube to move axially relative to the adapter.

59. The fitting as set forth in claim 58 wherein said internally tapered forward end portion is radially spaced from said tube when said fitting is made up.

60. The fitting as set forth in claim 58 wherein said internally tapered forward end portion is in contact with said tube when said fitting is made up.

61. The fitting as set forth in claim 58 wherein said internally tapered forward end portion includes a chamfer.

62. The fitting as set forth in claim 61 wherein said forward end portion includes a rounded tip.

63. The fitting as set forth in claim 58 wherein said internally tapered forward end portion tapers radially away from an outer surface of the tube in a direction from the rear portion toward the forward portion.

64. The fitting as set forth in claim 58 wherein the forward end portion includes a radius.

65. The fitting as set forth in claim 58 wherein the internally tapered forward end portion includes a radius and tapers radially away from an outer surface of the tube in a direction from the rear portion toward the forward portion.

66. The fitting as set forth in claim 58 wherein the fitting body defines a tapered socket that forms an angle of approximately 12 degrees or approximately 20 degrees with respect to a longitidinal axis of the fitting.

67. A fitting for connection with an end portion of a tube having an outer tube surface, said fitting comprising:
a fitting body having a tube socket for receiving the end portion of the tube, said fitting body including a tapered surface that is centered on an axis of the fitting body, the tapered surface extending at a first angle to the axis;
a ferrule having a front portion and a rear portion;
an adaptor ring; and
a driver for applying axial force to the ferrule rear portion to move the ferrule front portion into engagement with said adaptor ring;
said adaptor ring having a camming surface extending at a second angle to the axis for engagement by the ferrule front portion;
said adaptor ring being in sealing engagement with said fitting body when said fitting is made up;
said adapter ring having an internally tapered forward end portion radially spaced from the tube before the fitting is pulled up, and contacts the tube when the fitting is pulled up;
wherein the adapter remains in sealing engagement with the fitting body while allowing the tube to move axially relative to the adapter.

68. The fitting as set forth in claim 67 wherein the sealing engagement of said adaptor ring with said fitting body is metal to metal engagement.

69. The fitting as set forth in claim 67 wherein said adapter ring includes a rounded tip.

70. An adapter for use in a fitting for a tube having an outer surface comprising:
a forward end portion with a rounded tip and an inner surface that tapers radially away from an outer surface of the tube in a direction from a rear portion of the adapter toward a forward portion of the adapter.

71. The adapter of claim 70 wherein the adapter is configured to permit relative axial movement of the tube with respect to the adapter.

72. The adapter of claim 70 wherein the adapter is configured such that the tapered inner surface is spaced apart from the outer surface of the tube when the tube is pulled up.

73. The adapter of claim 70 wherein the adapter is configured such that the tapered inner surface contacts the outer surface of the tube when the tube is pulled up.

74. A fitting for connection with an end portion of a tube, said fitting comprising:
a first coupling member having a tube socket for receiving the end portion of the tube, said first fitting body including a tapered surface that is centered on an axis of the first coupling member, the tapered surface extending at a first angle to the axis;
a ferrule having a front portion and a rear portion;
an adapter; and
a second coupling member for applying axial force to the first ferrule rear portion to move the first ferrule front portion into engagement with said adapter;
said adapter having a camming surface extending at a second angle to the axis, the second angle being greater than the first angle;
said adapter being in sealing engagement with said first coupling member when said fitting is made up;
said adapter having a forward inside portion that forms an acute angle with respect to the tube before the fitting is pulled up such that a radial space between the adapter and the tube increases in a direction from the rear portion toward the forward portion before the fitting is pulled up.

75. The fitting as set forth in claim 74 wherein the sealing engagement of said adapter with said fitting body is metal to metal engagement.

76. The fitting as set forth in claim 74 wherein the first angle is about thirty degrees or less.

77. The fitting as set forth in claim 74 wherein the first angle is in the range of from about ten degrees to about fourteen degrees.

78. The fitting as set forth in claim 77 wherein the first angle is twelve degrees.

79. The fitting as set forth in claim 76 wherein the first angle is in the range of from about eighteen degrees to about twenty-two degrees.

80. The fitting as set forth in claim 79 wherein the first angle is twenty degrees.

81. The fitting as set forth in claim 74 wherein the second angle is in the range of from about forty three degrees to about forty seven degrees.

82. The fitting as set forth in claim 81 wherein the second angle is forty five degrees.

83. The fitting as set forth in claim 74 wherein the first angle is twelve degrees or twenty degrees and the second angle is forty five degrees.

84. The fitting as set forth in claim 74 further comprising a third ferrule between said first ferrule and said second coupling member.

85. The fitting as set forth in claim 74 wherein said tapered surface is adjacent to said tube socket.

86. The fitting as set forth in claim 74 wherein said forward inside portion of said adapter includes a radius.

87. The fitting as set forth in claim 74 wherein said forward inside portion of said adapter includes a chamfer.

88. The fitting as set forth in claim 74 wherein said forward inside portion of said adapter includes a radius and a chamfer.

89. A tube fitting for connection with an end portion of a tube, said tube fitting comprising:
a fitting body having a tube socket for receiving the end portion of the tube, said fitting body including a tapered surface;
a ferrule having a front portion and a rear portion;
an adaptor ring; and
a driver for applying axial force to the ferrule rear portion to move the ferrule front portion into engagement with said adaptor ring;
said adaptor ring having a camming surface for engagement by the front portion of the ferrule;
said adaptor ring having a sealing surface for engagement with the fitting body at a sealing location spaced apart from said tapered surface of said fitting body.

90. The tube fitting as set forth in claim 89 wherein said sealing location of said fitting body is an end face of said fitting body.

91. The tube fitting as set forth in claim 90 wherein said end face of said fitting body extends substantially normal to the axis and is presented toward said driver.

92. The tube fitting as set forth in claim 89 wherein said sealing location of said fitting body is an edge of said fitting body.

93. The tube fitting as set forth in claim 89 wherein said adaptor ring has a forward inside portion that has a taper that extends away from the tube in a direction from a rear portion of the adapter ring toward a front portion of the adapter ring.

94. A tube fitting as set forth in claim 93 wherein said forward inside portion of said adaptor ring includes a radius and a chamfer.

95. A tube fitting as set forth in claim 89 wherein said fitting body has a corner that is engaged by said adaptor ring in sealing engagement.

96. A tube fitting as set forth in claim 89 wherein said adaptor ring has a nose portion that extends radially inward of said tapered surface and that engages said tapered surface in sealing engagement.

97. A tube fitting as set forth in claim 89 wherein said fitting body has a radially extending back face and said adaptor ring has a radially extending front face that seals against said back face of said fitting body.

98. A method of connecting a tube end portion to a fitting that includes a coupling member, an adapter, and a ferrule, the method comprising:
a) forcing the ferrule into engagement with the adapter;
b) gripping the tube end portion with the ferrule;
c) allowing relative axial movement of the tube end portion with respect to the adapter by providing a gradual radially increasing space between the adapter and the tube end portion before pull up;
d) maintaining sealing engagement between the adapter and the coupling member during said relative axial movement.

99. The method of claim 98 wherein at least a portion of the radially increasing space remains between the adapter and the tube after pull up of the fitting.

100. The method of claim 98 wherein a portion of the radially increasing space is eliminated after pull up of the fitting.

101. The method of claim 98 wherein the radially increasing space is eliminated during pull up of the fitting.
